(19) United States
(12) Patent Application Publication
(10) Pub. No.: US 2002/0072939 A1
(43) Pub. Date: Jun. 13, 2002

(54) Server and method for supporting arrangements of event manager, and medium

(75) Inventor: Hiroyuki Kawaberi, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/945,726

(22) Filed: Sep. 5, 2001

(30) Foreign Application Priority Data
Dec. 8, 2000 (JP) 2000-374802

(51) Int. Cl. G06F 17/60

(52) U.S. Cl. 705/5

(57) ABSTRACT

A server (1), acts as a proxy between a user desiring to hold an event and a facility where the event takes place, for supporting arrangements of an event manager. The server comprises a communications module for communications between a user client (2a, 2b) for providing the user with an accessing function to a network and a facility client (3) serving as an information processing device of the facility on the network, a user information recording module (12) for recording information on the user, a facility information recording module (14) for recording information on the facility, and a control unit (11). The control unit (11) receives an event planing request notification from a first user client (2a), searches for a facility suited to this event, transmits a reservation-for-use notification to the facility client (3) searched, and notifies a second user client (2b) of a notice of the event.

### BACKGROUND OF THE INVENTION

The present invention relates to a technology for supporting event planning or an event management.

In a golf course etc., a situation of how much the facility is available has hitherto been displayed on a Web page via the Internet, thus inviting users. This kind of invitation is, however, simply to invite a reservation as whether the user uses the facility and is not to invite the users in order to plan and manage an event, for instance, a golf competition.

Further, an entrepreneur of the golf course and a tourist company have hitherto cooperated to plan a golf competition that takes place on the golf course on a predetermine date, and invited the participants. Moreover, an entrepreneur of a skiing ground and the tourist company have hitherto cooperated to plan a skiing tour and invited the participants. The event such as the golf competition and the skiing tour is schemed based on conveniences of the tourist company and the facilities at the golf course and the skiing ground. Therefore, the event can not be planned by directly taking in desires of the event participants.

Further, in that case, there was no chance for collecting the desires and needs of the event participants in the facilities other than the facility where the event took place. Moreover, even if there is a facility accommodating equipment by which the event desired by the users can be held, there was very few interface for accessing the users. Accordingly, there was a case wherein the users are unable to hold the desired event at a desired time in a facility suited to this event.

Such being the case, the user who is enthusiastic about holding the event at the desired time in the facility suited to this event, has hitherto been appointed an event manager, and the event has been planned and managed on the premise that the manager is burdened with such arrangements.

### SUMMARY OF THE INVENTION

It is a primary object of the present invention, which was devised to obviate the above problems inherent in the prior art, to actualize a system capable of supporting arrangements of an event manager who plans and manages an event, acting as a proxy of works of the manager, and holding the event in which desires of user are reflected.

It is another object of the present invention to provide a system by which an entrepreneur for providing a facility where the event takes place is able to grasp desires and needs of users who do not yet utilize such a facility.

To accomplish the above objects, according to one aspect of the present invention, a server (1), acting as a proxy between a user desiring to hold an event and a facility where the event takes place, for supporting arrangements of an event manager, comprises a communications module for communications between a user client (2a, 2b) for providing the user with an accessing function to a network and a facility client (3) serving as an information processing device of the facility on the network, a user information recording module (12) for recording information on the user, a facility information recording module (14) for recording information on the facility, and a control unit (11),wherein the control unit (11) receives an event planing request notification from a first user client (2a), searches for a facility suited to this event out of the facility information recording module (14), transmits a reservation-for-use notification to the facility client (3) of the facility searched, and notifies a second user client (2b) recorded on the user information recording module (12), of a notice of the event.

Preferably, the control unit (11) may notify a plurality of facility clients (3) of temporary reservations, and, after receiving a reservation request from the first user client (2a) notify each of the facility clients (3) notified of the temporary reservations, of either a formal reservation or a cancel of temporary reservation.

Preferably, the control unit (11), together with the cancel of the temporary reservation, may notify the facility client (3) of the facility with the temporary reservation canceled, of disclosure information on participants in the event concerned.

Preferably, the control unit (11) may accept an application for the participation in the event from the second user client.

Preferably, a condition about at least one of a category of the event to be held, an event holding date and time, an event holding location and a budget, may be specified in the event planning request notification.

Preferably, a priority maybe specified as the condition.

Preferably, the server (1) may further comprise a group recording module (13) for recording groups to which the users belong, wherein planning of an event for a given group may be requested in the event planning request notification, and the control unit (11) may inform the user client (2b) of the user belonging to the group concerned, of the notice of the event.

Preferably, the group recording module (13) maybe recorded with pieces of information showing categories of the events desired by the respective groups and information on an event count indicating how many times the event takes place, and the control unit (11) may predict a time when the next event will takes place on the basis of the event count, and may notify the user clients (2, 2a, 2b) of an event planning notice before the predicted event take-place time.

According to another aspect of the present invention, an event proxy method for a proxy between a user desiring to hold an event and a facility where the event takes place in a system including a user client (2a, 2b) serving as a device for accessing a network and a facility client (3) serving as an information processing device of the facility on the network, comprises a step of receiving an event planning request notification from a first user client, a step (S11) of searching for a facility suited to this event, a step (S24) of transmitting a reservation-for-use notification to the facility client (3) of the facility searched, and a step (S36) of informing a second user client of a notice of the event.

According to a further aspect of the present invention, there is provided a readable-by-computer recording medium recorded with a program executed by a computer to provide the functions described above.

As explained above, according to the present invention, it is feasible to support the arrangements of the event manager who plans and manages the event, act as the proxy for the works of the manager and hold the event in which the desires of the users are reflected.

### BRIEF DESCRIPTION OF THE DRAWINGS

FIG. 1 is a diagram showing an architecture of an event proxy system 1 in an embodiment of the present invention;

FIG. 2 is a diagram showing a flow of processing by the event proxy system 1;

FIG. 3 is a diagram showing a data structure of a user information database 12;

FIG. 4 is a diagram showing a data structure of a group information database 13;

FIG. 5 is a diagram showing a data structure of a facility information database 14;

FIG. 6 is a diagram showing a data structure of a temporary reservation user information database 16;

FIG. 7 is a diagram showing a data structure of a temporary reservation facility information database 17;

FIG. 8 is a diagram showing an initial input screen of the event proxy system 1;

FIG. 9 is a diagram showing an event take-place information input screen;

FIG. 10 is a diagram showing a result-of-search screen;

FIG. 11 is a diagram showing a temporary reservation confirmation screen;

FIG. 12 is a diagram showing a temporary reservation notification screen;

FIG. 13 is a diagram showing a pre-notice creation screen;

FIG. 14 is a diagram showing a formal contract screen;

FIG. 15 is a diagram showing a cancel screen;

FIG. 16 is a flowchart showing a participant registration process;

FIG. 17 is a flowchart showing an event search process;

FIG. 18 is a flowchart showing a result-of-search receiving process;

FIG. 19 is a flowchart showing a temporary reservation setting process;

FIG. 20 is a flowchart showing a formal reservation setting process; and

FIG. 21 is a flowchart showing an entrepreneur registration process.

### DETAILED DESCRIPTION OF THE PREFERRED EMBODIMENT

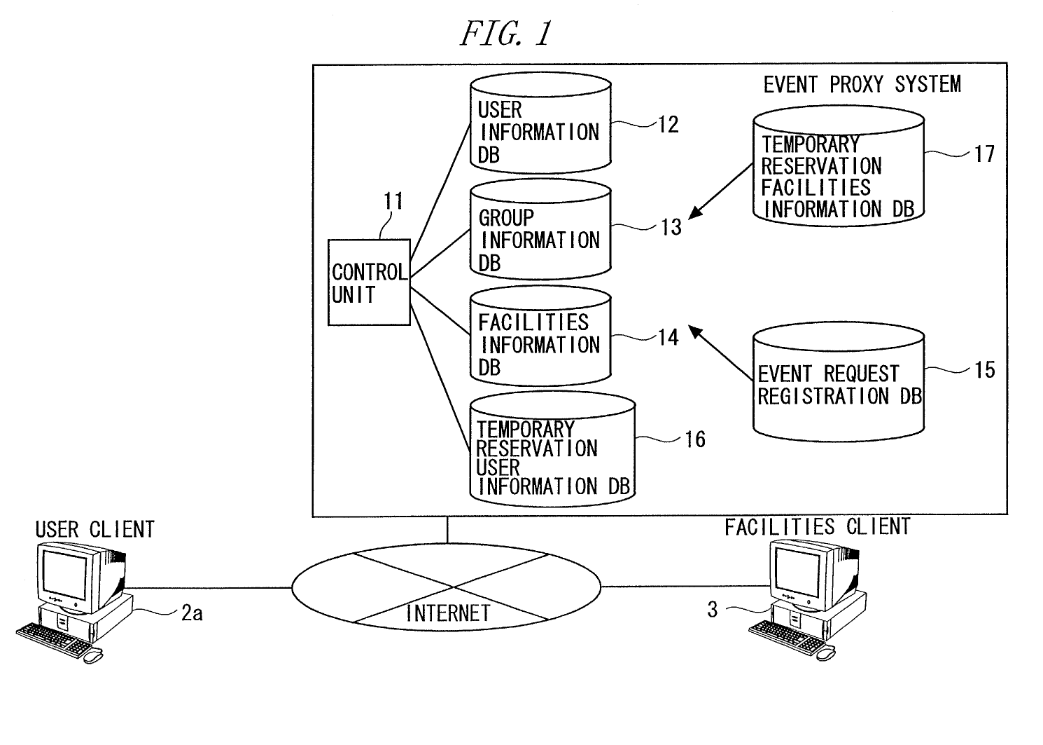

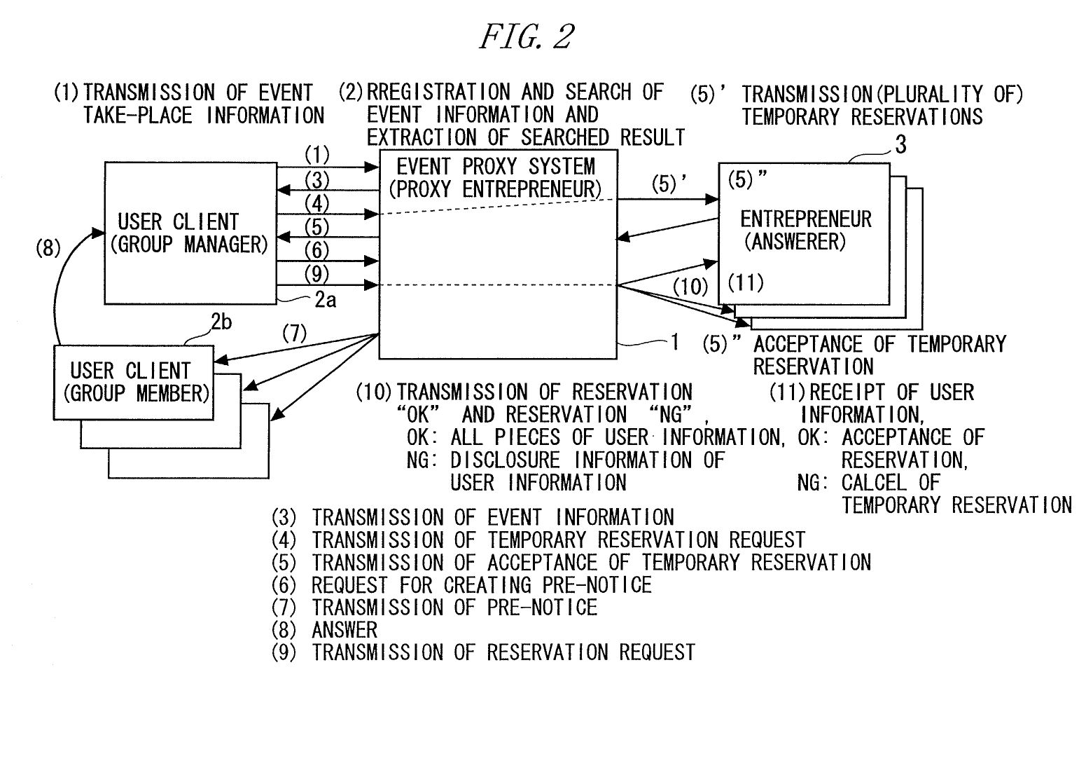

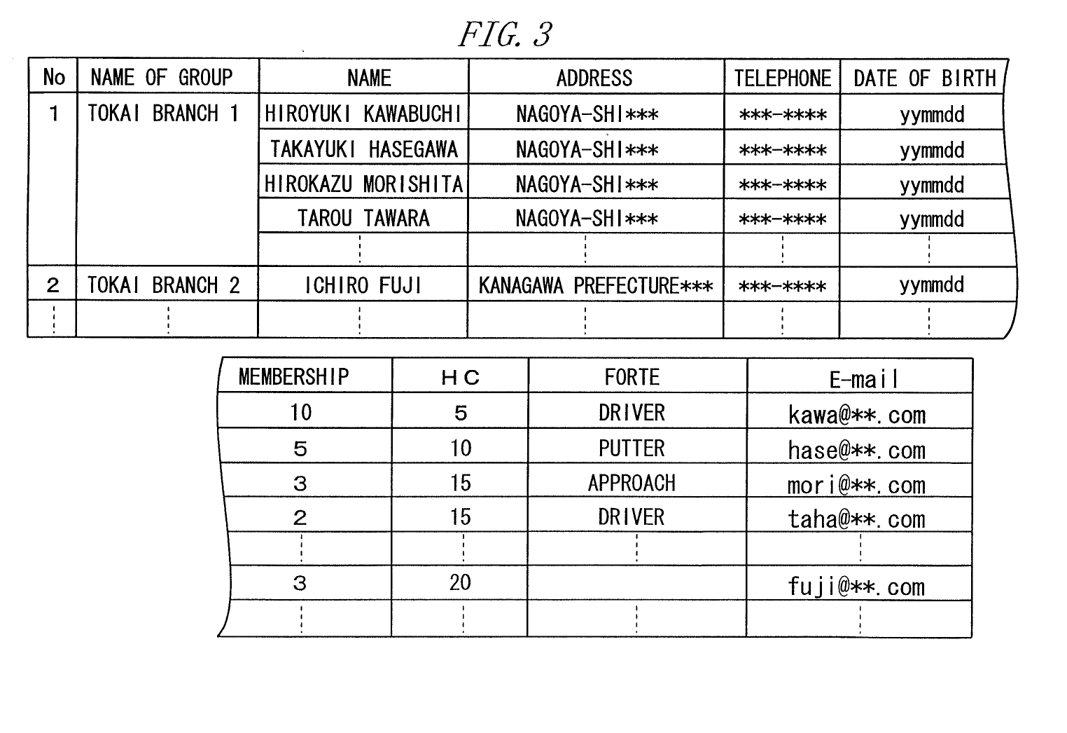

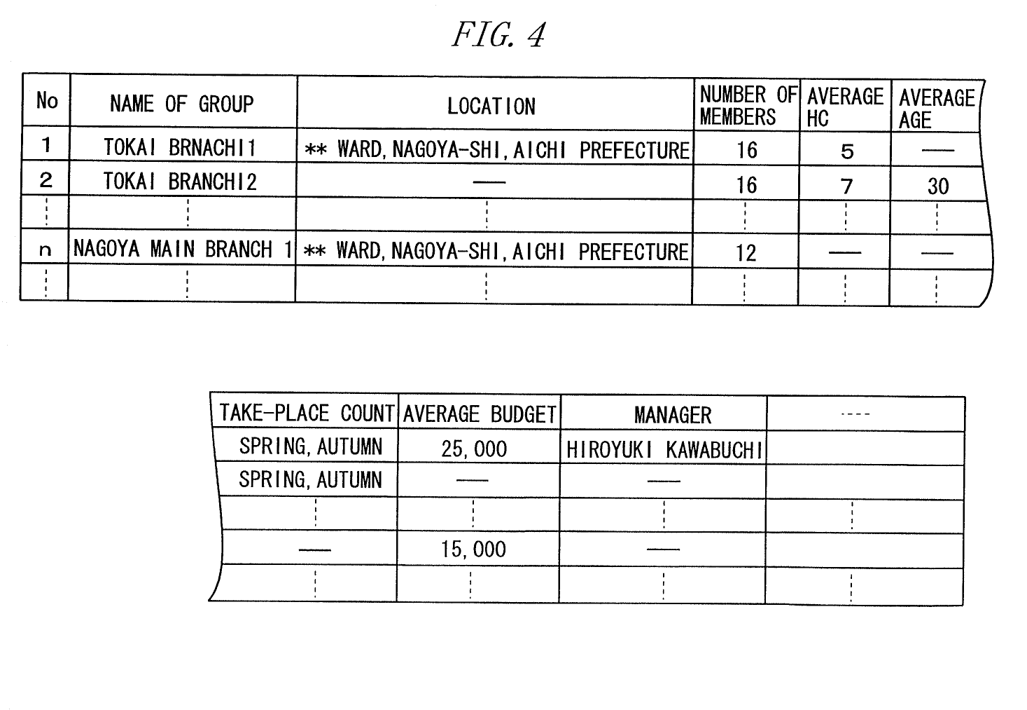

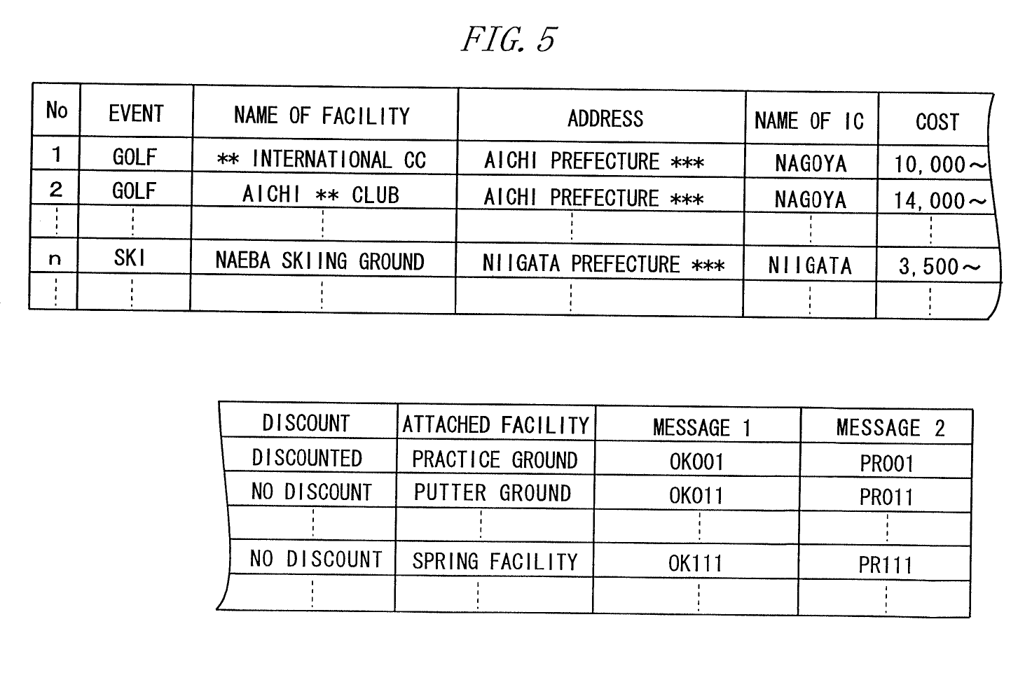

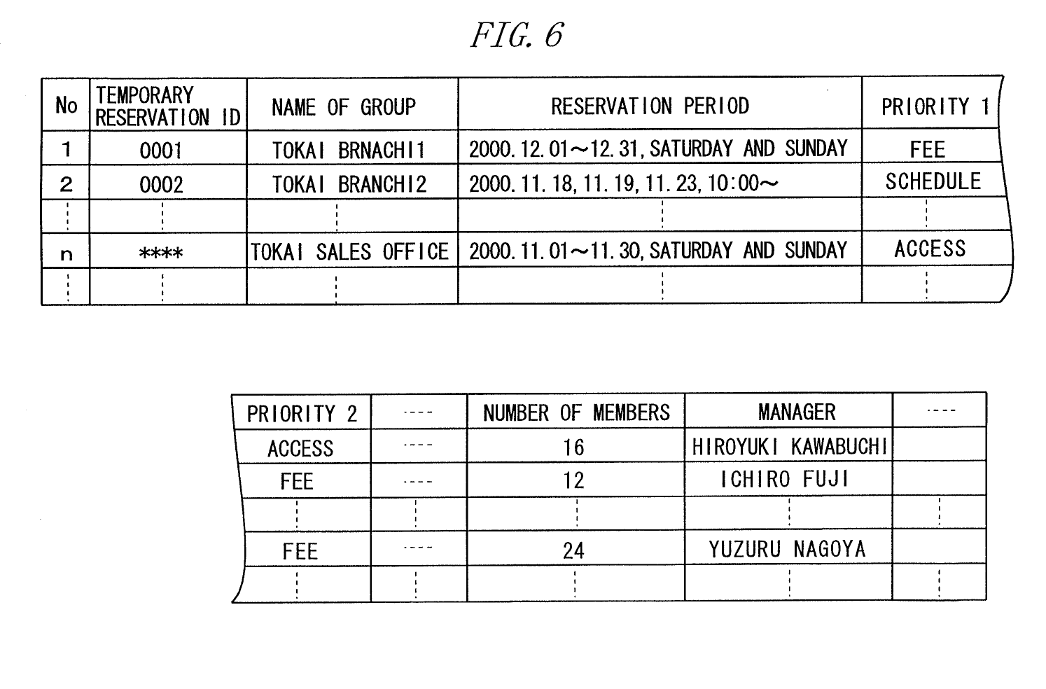

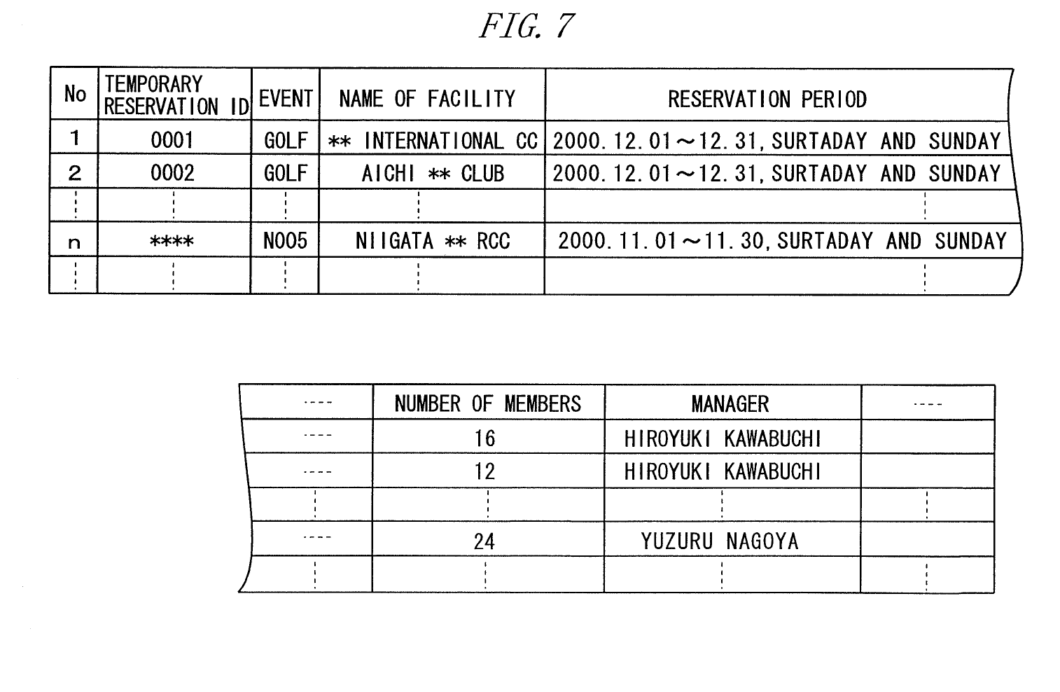

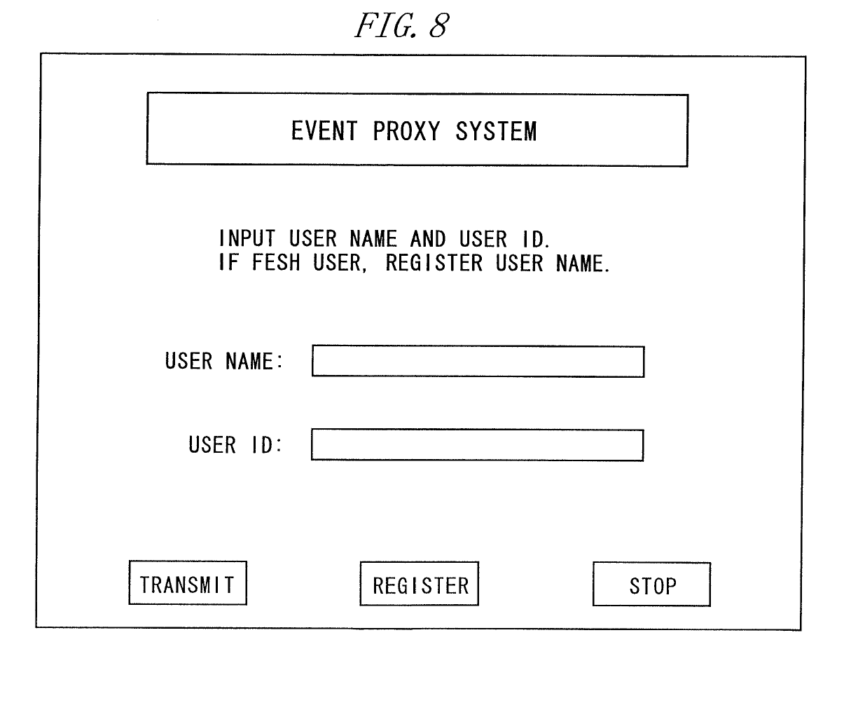

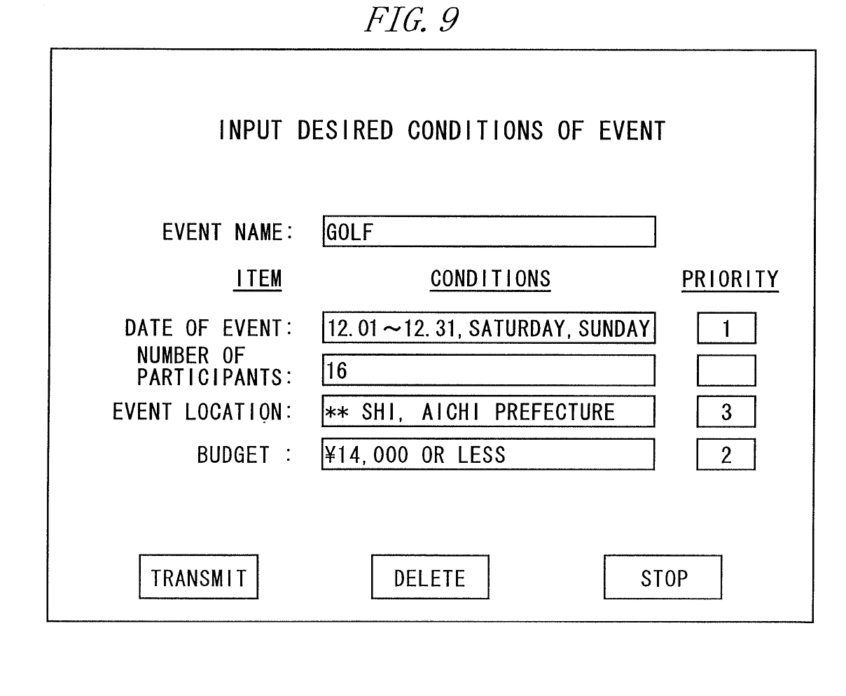

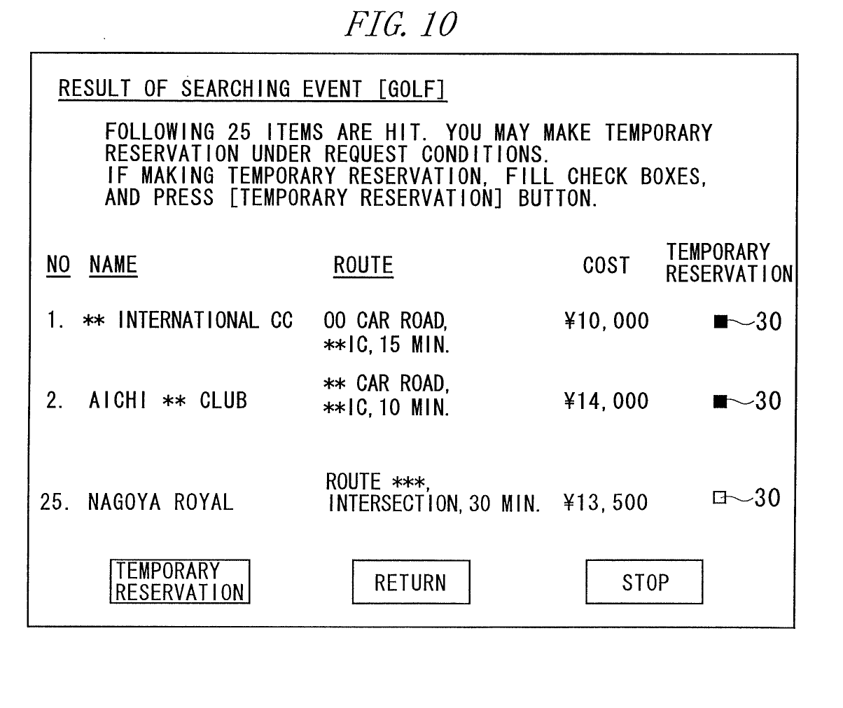

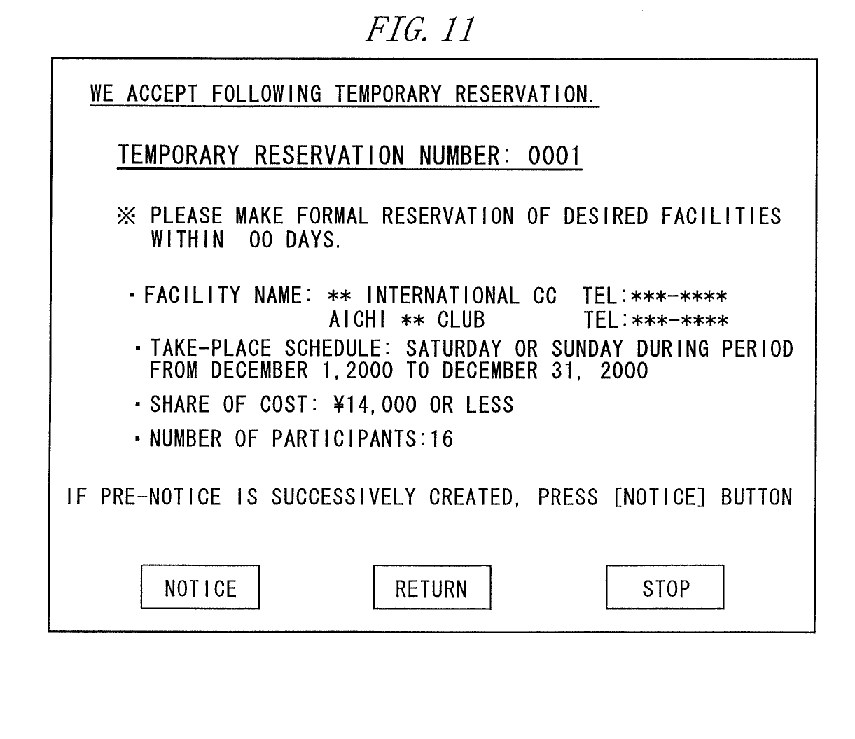

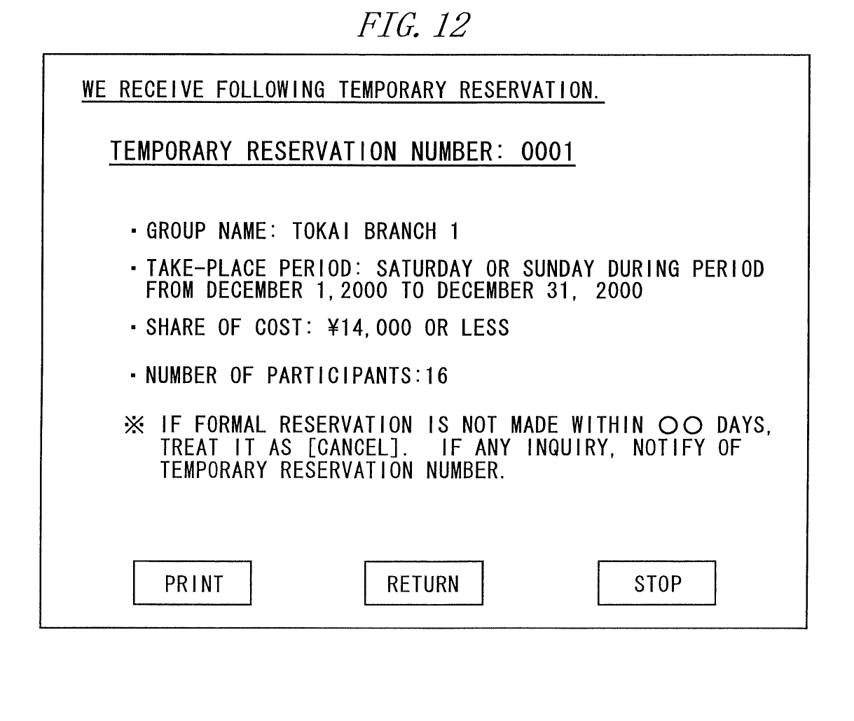

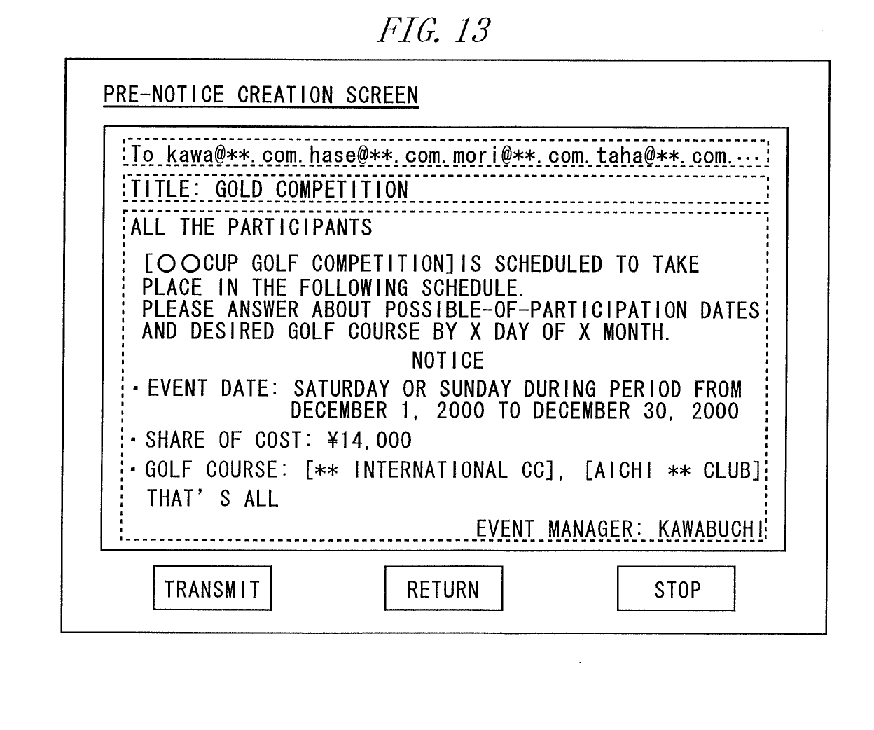

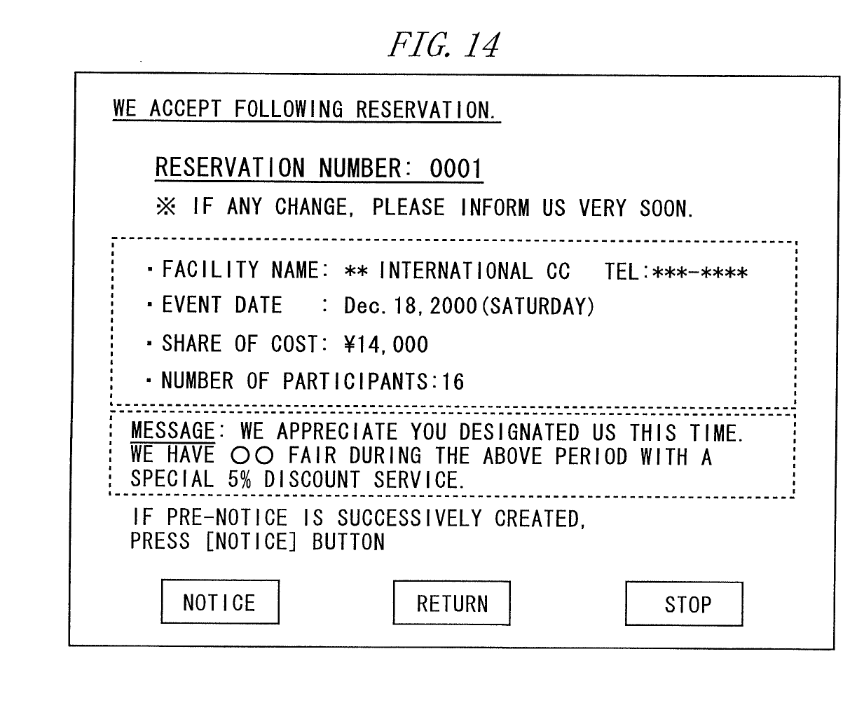

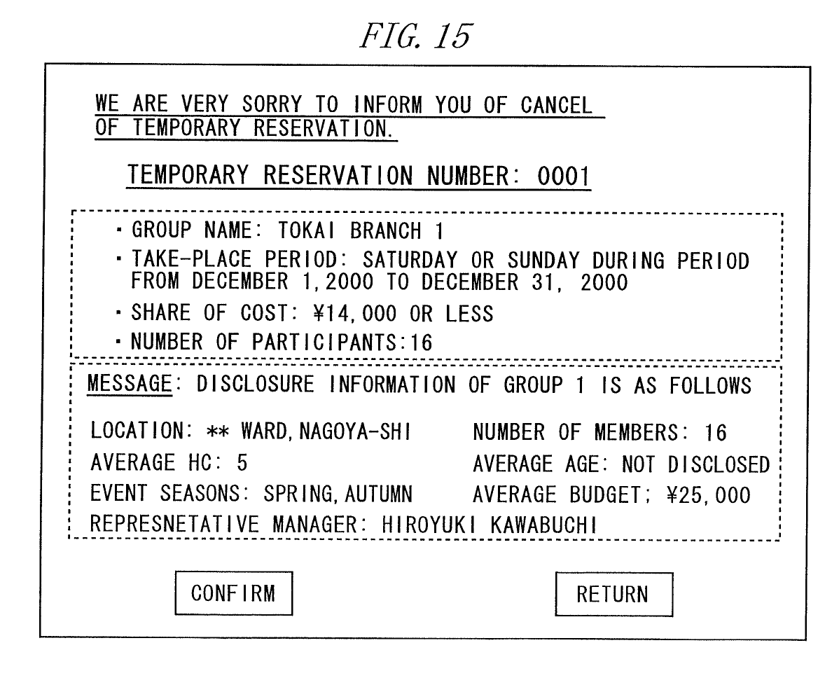

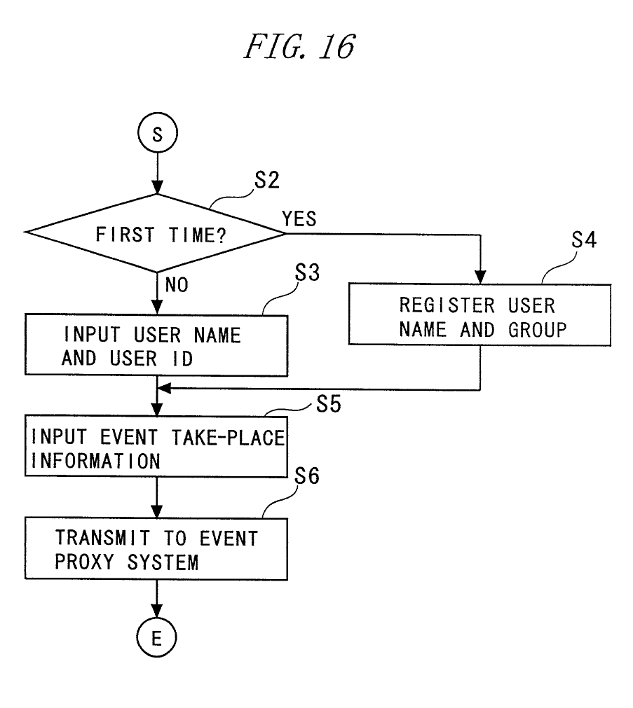

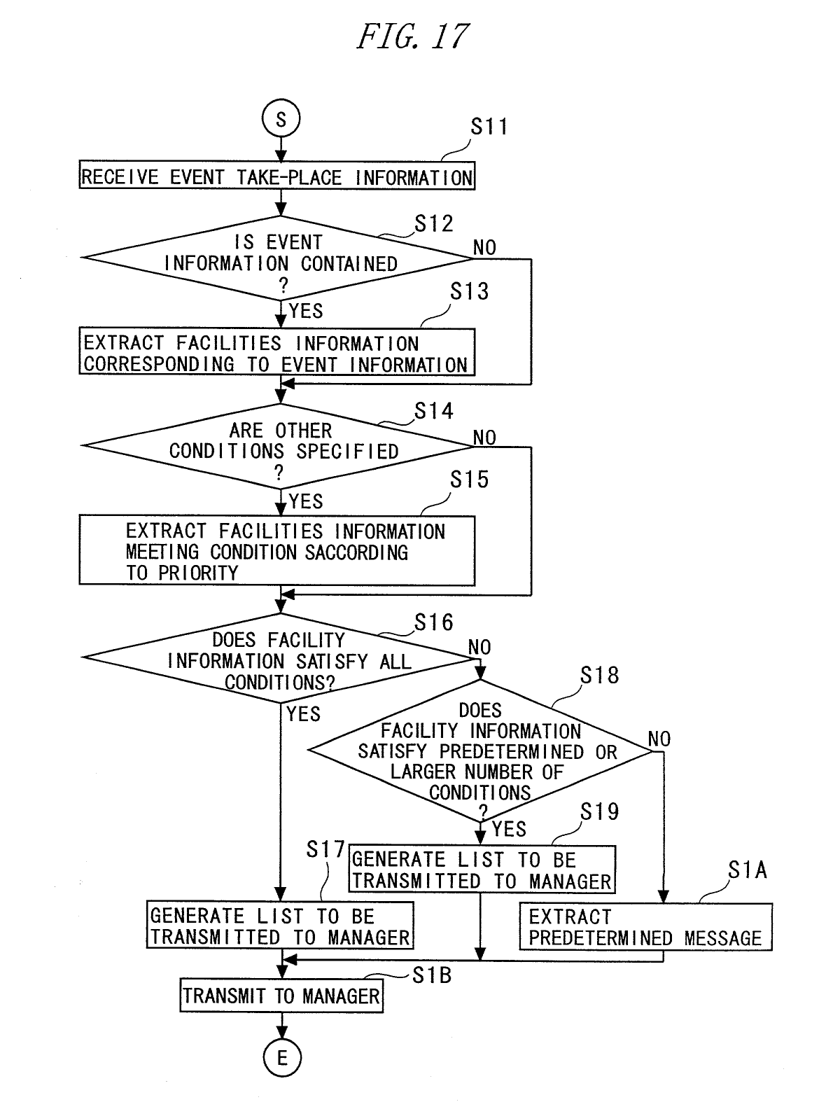

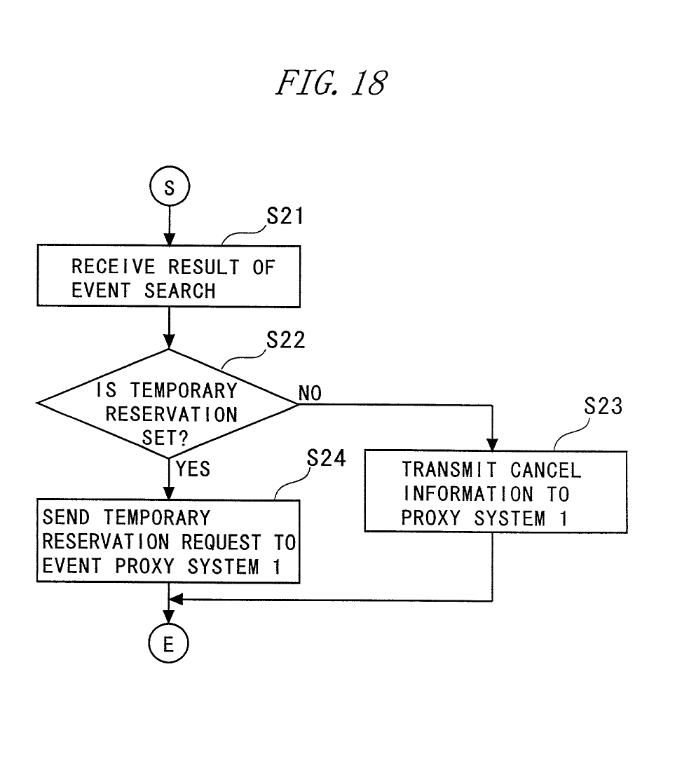

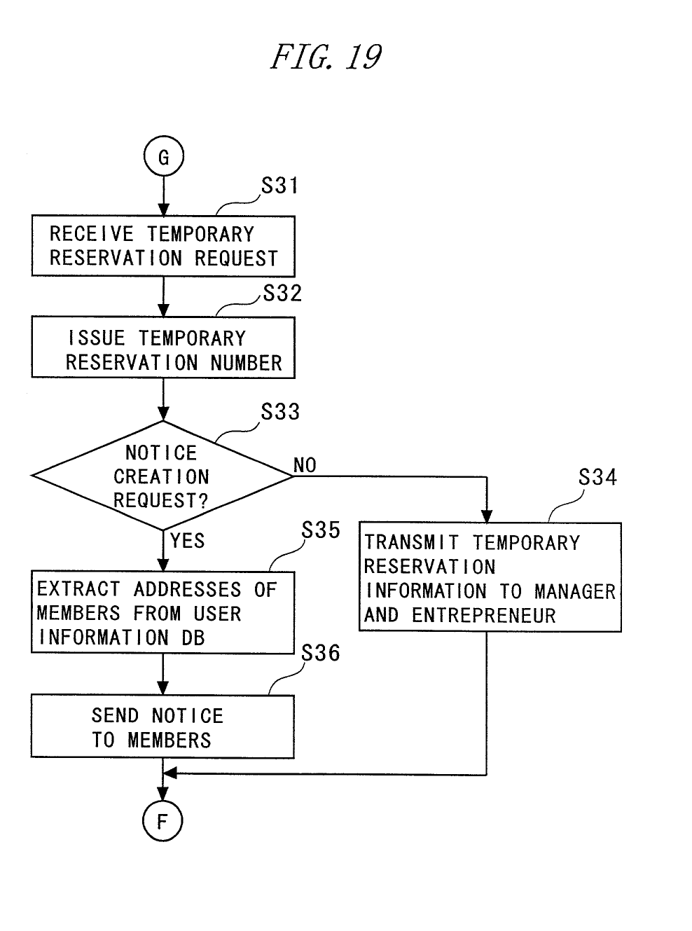

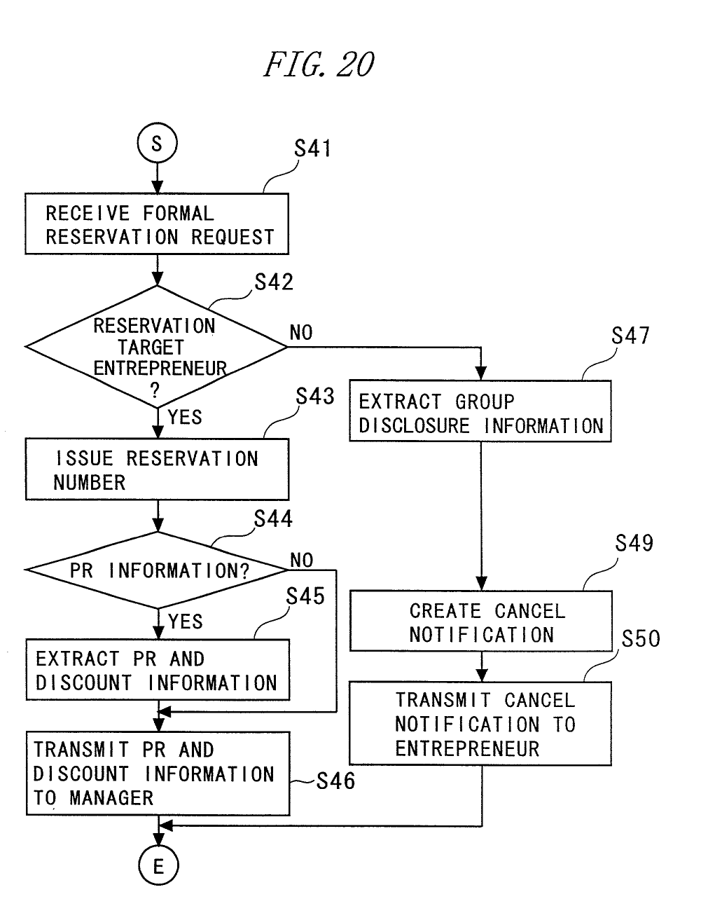

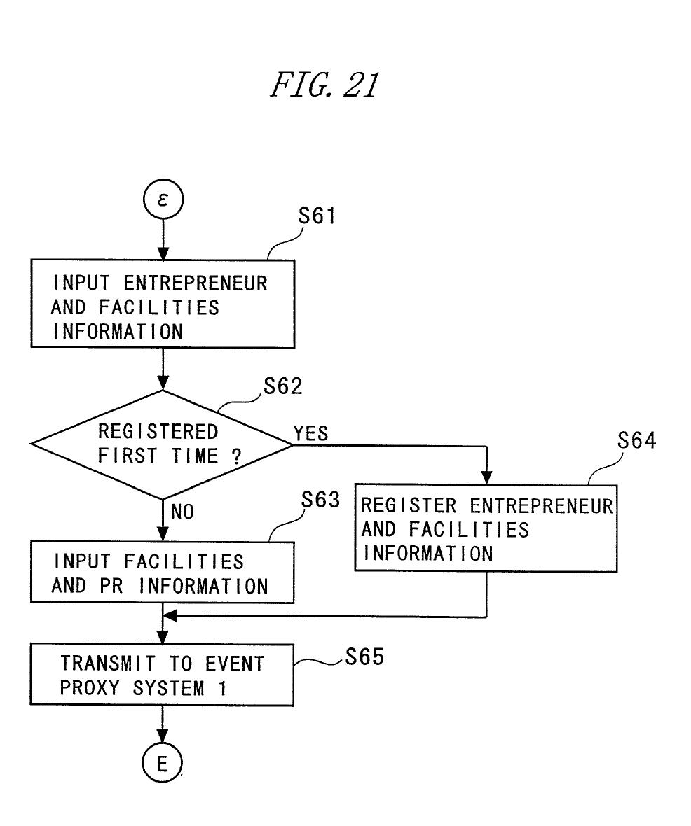

FIG. 1 is a diagram showing an architecture of an event proxy system 1 (corresponding to a server). FIG. 2 is a diagram showing a processing flow by this event proxy system 1. FIG. 3 is a diagram showing a data structure of a user information database 12 shown in FIG. 1 (the database will hereinafter be shown as an abbreviation “DB” as in FIG. 3). FIG. 4 is a diagram showing a data structure of a group information DB 13 shown in FIG. 1. FIG. 5 is a diagram showing a data structure of a facility information DB 14 shown in FIG. 1. FIG. 6 is a diagram showing a data structure of a temporary reservation user information DB 16 shown in FIG. 1. FIG. 7 is a diagram showing a data structure of a temporary reservation facility information DB 17 shown in FIG. 1. FIGS. 8 and 9 are diagrams each showing an input screen displayed on a user client 2a by the event proxy system 1. FIG. 10 is a diagram showing a result-of-search screen displayed on the user client 2a by the event proxy system 1. FIG. 11 is a diagram showing a temporary reservation confirmation screen for indicating a result of the temporary reservation, which is displayed on the user client 2a by the event proxy system 1. FIG. 12 is a diagram showing a temporary reservation notifying screen displayed on a facility client 3 by the event proxy system 1. FIG. 13 is a diagram showing a pre-notice creation screen displayed on the user client 2a by the event proxy system 1. FIG. 14 is a diagram showing a final contract screen displayed on the user client 2a by the event proxy system 1. FIG. 15 is a diagram showing a cancel screen displayed on the facility client 3 by the event proxy system 1. FIG. 16 is a flowchart showing a participant registration process executed by the user client 2a. FIG. 17 is a flowchart showing an event search process executed by the event proxy system 1. FIG. 18 is a flowchart showing a result-of-search receiving process executed by the user client 2a. FIG. 19 is a flowchart showing a temporary reservation setting process executed by the event proxy system 1. FIG. 20 is a flowchart showing a formal reservation setting process executed by the event proxy system 1. FIG. 21 is a flowchart showing an entrepreneur registration process executed by the facility client 3.

<System Architecture>

FIG. 1 is the diagram showing the architecture of the event proxy system 1 in this embodiment. This event proxy system 1 is connected via the Internet to a client device 2a (which is hereinafter simply called a user client 2a) used by a user and also to a client device 3 (which is hereinafter simply called a facility client 3), wherein the event proxy system 1 provides these clients with event proxy functions.

As shown in FIG. 1, the event proxy system 1 includes a control unit 11, a user information database (DB) 12, a group information DB 13, a facility information DB 14, an event request registration DB 15, a temporary reservation user information DB 16 and a temporary reservation facility DB 17, which are accessed from the control unit 11. Th DBs in these categories, if generically termed, are hereinafter called the variety of databases.

The control unit 11 is constructed of a so-called CPU and an I/O interface. This I/O interface contains interfaces to the variety of databases and a communications interface (corresponding to a communications module) to the network.

The control unit 11 executes a variety of programs, thereby controlling the event proxy system 1. Further, the control unit 11 accesses the variety of databases and administers the information. Moreover, the control unit 11, based on the information stored on the variety of databases, provides the user client 2a and the facility client 3 with a function as the event proxy system 1.

The user information DB 12 is a database registered with users receiving services from the event proxy system 1. The users register predetermined items of information beforehand for receiving the services from the present event proxy system 1.

The group information DB 13 is a database stored with records for defining groups to which the users respectively belong. The group in terminology is herein defined as an organization including a plurality of users as in the case of working places, private circles and so on. When the first user belonging to each group is registered in the present event proxy system 1, this group is defined at the same time.

The facility information DB 14 is a database stored with pieces of information on facilities where events take place. The information on the facility information DB 14 is inputted beforehand by the entrepreneur of the facility via the Internet.

The event request registration DB 15 registers an event plan request given from the user client 2a, and administers the requests from the users.

The temporary reservation user information DB 16 is, when making a temporary reservation of the facility utilized for the event, stored with pieces of information on the user who made the temporary reservation and so on. On the other hand, the temporary reservation facility information DB 17 is stored with information on temporary reservation target facilities.

An event manager (who will hereinafter be called a group manager) accesses the event proxy system 1 via the Internet by using the user client 2a, and requests the event proxy system 1 for planning and managing an event.

On the other hand, the entrepreneur of the facility registers beforehand the information on the facility concerned through the facility client 3. Then, the facility client 3 accepts a temporary reservation and a formal reservation from the event proxy system 1.

<Flow of Processing>

FIG. 2 is the diagram showing a flow of processing by the event proxy system 1. FIG. 2 shows a series of processes executed by the event proxy system 1 along with its processing sequence. According to this system 1, every user is to belong to any one of the groups. The users belonging to the group are called group members. Every group involves a group manager. The group manager acts as a human interface to the event proxy system 1, and requests the event proxy system 1 to scheme an event and to reserve a facility.

To start with, the user appointed as the group manager transmits event take-place information (corresponding to event planing request notification) to the event proxy system 1 through the user client 2a (corresponding to a first user client) of the user himself or herself.

This item of event take-place information contains pieces of event information such as an event name defined as a category of the event to be held, an event take-place date, an event take-place location or an event budget. These pieces of information are specified corresponding to an event that the group manager desires to hold. Among these pieces of information, the event names are, for example, a golf competition, a baseball practice game, a skiing tour, a banquet, an exhibition and so forth.

The event take-place information is transferred to the event proxy system 1 by an E-mail, a chat on a web page provided by the event proxy system 1 or by writing on an electronic bulletin board provided on the web page.

The event proxy system 1, when receiving the event take-place information, registers this item of information on the event request registration DB 15. Next, the event proxy system 1 extracts pieces of information on the facility utilized for that event by searching the facility information DB 14. For instance, if a category of the requested event is the golf competition, the event proxy system 1 extracts the information on available golf courses by searching the facility information DB 14, wherein the “golf” is inputted as the keyword.

If the event take-place information does not contain an event name indicating a category of the event, however, the facility information conforming with other conditions such as an event take-place period, an event budget and so on.

Next, the event proxy system 1 transmits the event information together with the extracted facility information to the user client 2a of the group manager. These items of information are displayed on the user client 2a.

The group manager confirms the facility information displayed, the selects a desired facility, and transmits a temporary reservation request by use of the user client 2a. The event proxy system 1 receiving the temporary reservation request registers, on the temporary reservation user information DB 16, a user name of the group manager having sent this temporary reservation request.

Further, the event proxy system 1 transmits the temporary reservation to the facility client 3 of the facility specified by the temporary reservation request. Responding to this, the facility client 3 of this facility accepts the temporary reservation, and sends a reply of the acknowledgement back to the event proxy system 1.

The event proxy system 1 receiving the acknowledgement of the temporary reservation transmits an acceptance of the temporary reservation to the user client 2a of the group manager. The temporary reservation acceptance is defined as a notification that the system 1 informs the group manager that each facility has accepted the temporary reservation.

Next, the group manager requests the event proxy system 1 through the user client 2a to create and distribute (multicast) a pre-notice. Then, the event proxy system 1 searches templates of the pre-notice, which are prepared for respective categories of the events.

The event proxy system 1 inputs peculiar pieces of information to this event such as an event take-place date, a share of event cost, a facility, etc. to (input boxes of) the searched template, thus creating the pre-notice. The pre-notice is displayed on the user client 2a. The group manager may edit manually this pre-notice. Then, the event proxy system 1 multicasts the created pre-notice to user clients 2b (each corresponding to a second user client) of the group members.

Each of the group members receiving the pre-notice transmits an answer of participation in a desire-for-participating event to the user client 2a of the group manager by use of the user client 2b. The user client 2a of the group manager collects the answers of participation in the event.

When the number of participants in the event comes to a predetermined value or larger, the event manager transmits the reservation request to the event proxy system 1. According to this reservation request, the facility desired by the group manager is specified among the temporarily reserved facilities.

The event proxy system 1 transmits reservation “OK” (corresponding to a formal reservation) to the facility client 3 of the reservation request target facility. In this case, the event proxy system 1 simultaneously transmits all pieces of user information on the event participants.

On the other hand, the event proxy system 1 notifies the temporarily reserved facilities ruled out of the reservation target of reservation “NG” (corresponding to a cancel of the temporary reservation) and of disclosure information of the group of the event participants. The disclosure information implies pieces of information of which a disclosure is permitted by each group among the items of information registered on the group information DB 13.

<Data Structure>

FIGS. 3 through 7 show data structures of the variety of databases provided in the event proxy system 1. FIG. 3 is the diagram showing a data structure of the user information DB 12. As shown in FIG. 3, each record of the user information DB 12 consists of a set of data entered in fields such as a “No.” field, a “name of group” field, a “name” field, an “address” field, a “telephone number” field, a “date of birth” field, a “membership” field, a “handicap” (displayed as HC in FIG. 3) field, a “forte” field and an “E-mail” field. Each record (corresponding to each line in FIG. 3) of the user information DB 12 contains a set of information on each user.

A group number for identifying the group to which the user belongs is entered in the “No.” field among these fields. The name of group is a name of the group to which each user belongs. Further, the “membership” field is stored with a facility number (which is a numerical value in the “No.” field of each set of data of the facility information DB 14 shown in FIG. 5) of the facility whose membership is given to the user concerned. The handicap (HC) is a handicap given to the user in the golf competition. The forte indicates a category of a club that the user is comparatively good at using.

FIG. 4 shows a data structure of the group information DB 13. As shown in FIG. 4, each record of the group information DB 13 consists of a set of data entered in a “No.” field, a “name of group” field, a “location” field, a “number of members” field, an “average handicap” field, an “average age” field, a “take-place count” field, an “average budget” and a “manager” field. Each record (corresponding to each line in FIG. 4) of the group information DB 13 contains a set of information on each group.

Among these fields, the “No.” and “name of group” fields are, as in the case of the user information DB 12, stored with a group number and a name of group that identify the group.

Further, the location indicates where the group exists. For example, if the group is a group organized in a working place, the location is an address of this working place. The number of members is the number of users who form the group. The average handicap (HC) is an average handicap among the users within the group.

The average age is an average of ages of the users within the group. The take-place count is a piece of data indicating the number of times the event, e.g., the golf competition of the group concerned takes place annually. The average budget is an average value of the expenditures paid per event. The “manager” field is stored with information, e.g., a name for identifying the present group manager of each group.

In the fields of the records of data of the group information DB 13 shown in FIG. 4, the symbol “-” displayed therein implies undisclosed information. The data excluding the undisclosed information are disclosed to the facility client 3.

FIG. 5 shows a data structure of the facility information DB 14. As shown in FIG. 5, the facility information DB 14 has a “No.” field, an “event” field, a “name of facility” field, an “address” field, a “name of interchange (IC)” field, a “cost” field, a “discount” field, an “attached facility” field, a “message 1” field and a “message 2” field. Each record (corresponding to each line in FIG. 5) of the facility information DB 14 contains a set of information corresponding to each facility.

A numerical value in the “No.” field is a serial number for identifying each record of data of the facility information DB 14. This serial number is used as a facility number for identifying the facility. The event is defined as a keyword indicating a category of the event suited to the facility concerned. For instance, a golf is entered in the “event” field, this implies that the facility concerned is suited to a golf competition. Further, skiing is entered in the “event” field, this indicates that this facility is possible of skiing.

A name of the facility is entered in the “name of facility” field. The address is a location of the facility concerned. The name of interchange (IC) is a name of the interchange of a highway closest to the facility concerned. The cost is a minimum charge per user for using the facility once.

The “discount” field shows whether the facility concerned has a discount system or not. The “attached facility” field shows categories of main attached facilities. These attached facilities are, for example, a practice ground or room, a hot spring facility and soon. The “message 1” and “message2” fields are stored with messages addressed to the users from the facility concerned. These messages are, when the facility is, for example, reserved, sent automatically by the event proxy system 1 to the user clients 2a, 2b.

FIG. 6 shows a data structure of the temporary reservation user information DB 16. As shown in FIG. 6, the temporary reservation user information DB 16 has a“No.” field, a “temporary reservation ID” field, a “name of group” field, a “reservation period” field, a “priority 1” field, a “priority 2” field, a “number of members” field and a “manager” field.

The “No.” field shows a serial number for identifying each record of data of the temporary reservation user information DB 16. The temporary reservation ID is an identification number for identifying the temporary reservation. The “name of group” field shows a name of the group that made the temporary reservation. The reservation period is a roughly set period for including a schedule date on which the facility is finally reserved.

The “priority 1” field shows a condition given a first priority among facility selection conditions in the case of making a formal reservation. Similarly, the “priority 2” field shows a facility selection condition given a second priority. The “number of members” field shows the number of members who make the temporary reservation. The “manager” field is stored with information, e.g., a name for identifying the group manager.

FIG. 7 shows a data structure of the temporary reservation facility information DB 17. As shown in FIG. 7, the temporary reservation facility information DB 17 has a “No.” field, a “temporary reservation ID” field, an “event” field, a “name of facility” field, a “reservation period” field, a “number of members” field and a “manager” field.

The fields other than the “event” and “name of facility” fields among these fields are the same as those of the temporary reservation user information DB 16 shown in FIG. 6. The “event” field is recorded with a category of the event that will take place in the temporary reservation target facility. Further, the name of facility is a name of the temporary reservation target facility.

<Configuration of Screen Display>

FIGS. 8 through 15 show configurations of displays on screens provided to the user clients 2a, 2b or the facility client 3 from the event proxy system 1. These screens are provided as web pages on the Internet or as text files of E-mails delivered from the event proxy system 1.

FIG. 8 shows an initial input screen of the event proxy system 1 when the group manager accesses at first the same system 1 by using the user client 2a. This screen is provided with a user name input box and a user ID input box at the center on the screen, and “transmit”, “register” and “stop” buttons at the lower portion on the screen.

The group manager inputs the user name and the user ID to the input boxes on this initial input screen, and clicks the “transmit” button by an unillustrated pointing device, e.g., a mouse. Then, an event take-place information input screen shown in FIG. 9 is displayed.

When accessing this event proxy system 1 for the first time, however, the event manager is required to register a user name by pressing the “register” button and to determine a user ID. Further, when the “stop” button is pressed, the user client 2a is disconnected from the event proxy system 1.

FIG. 9 shows the event take-place information input screen for inputting pieces of information on the event that the event manager desires to hold. This screen has an input box for inputting an event name, input boxes for inputting event take-place conditions such as an event date, the number of participants, an event location and a budget, and also priority boxes for inputting a priority of each condition. Further, this screen is provided with “transmit”, “delete” and “stop” buttons at the lower portion thereof.

The event name input box is a box for inputting a keyword showing a category of the event that the event manager desires to hold. The categories of events to be specified are, for instance, a golf, a baseball, an athletic meet, skiing, a banquet, an exhibition and so on.

A period including a scheduled date when the event will take place, is specified as an event date. For example, if the event is to take place any Saturday and Sunday in December, the event date is specified such as 12.01˜12.31 Sat.Sun.

The priority box shows which condition among the event take-place conditions is given a higher priority when holding the event. Then, the facilities where the event takes place are selected in sequence from the one that meets the condition given the higher priority.

When the event manager presses the “transmit” button after setting those conditions, the conditions are transmitted to the event proxy system 1. Then, the event proxy system 1 next searches for the facilities corresponding to the specified conditions from the facility information DB 14 shown in FIG. 5, and displays these facilities on a result-of-search display screen.

Further, the event manager may delete the temporary reservation already registered in the event proxy system 1 by pressing the “delete” button. Moreover, when the “stop” button is pressed, the user client 2a is disconnected from the event proxy system 1.

FIG. 10 shows the result-of-search display screen. A list of the names of facilities, routes, costs conforming with the event conditions, is displayed together with temporary reservation specifying buttons 30 on this screen. On this display screen, a display priority is given to the facility conforming with the higher-priority condition specified in FIG. 9. Moreover, “temporary reservation”, “return” and “stop” buttons are displayed at the lower portion on the result-of-search display screen.

The route in this list is defined as information for an easy access to the facility, containing the nearest interchange, station and so on. For instance, the information such as “OO Car Road/Interchange/15 min.” is displayed.

Further, the event manager sets a temporary reservation of a desired facility in the list of facilities displayed thereon. The temporary reservation is set by pressing the temporary reservation specifying button 30 with an unillustrated pointing device. After this setting, when event manager presses the “temporary reservation” button, the setting of the temporary reservation is transmitted to the event proxy system 1. Then, the event proxy system 1 displays a temporary reservation confirmation screen on the user client 2a for the event manager to confirm contents of the temporary reservation.

If the event manager presses the “return” button, however, the event take-place information input screen shown in FIG. 9 is displayed. Further, if the event manager presses the “stop” button, the user client 2a is disconnected from the event proxy system 1.

Note that the event proxy system 1, when the temporary reservation is made, records the information displayed on the result-of-search screen on the temporary reservation user information DB 16 shown in FIG. 6 or on the temporary reservation facility information DB 17 shown in FIG. 7.

FIG. 11 shows the temporary reservation confirmation screen. A temporary reservation number, a facility name of the temporarily reserved facility, an event date (take-place schedule), a share of cost and the number of members, are displayed on the temporary reservation confirmation screen. Further, “notice”, “return” and “stop” buttons are displayed at the lower portion on this screen.

When the event manager presses the “notice” button, a pre-notice creation screen is displayed. When the event manager presses the “return” button, the result-of-search display screen shown in FIG. 10 is displayed. Further, when the event manager presses the “stop” button, the temporary reservation is canceled, and the user client 2a is disconnected from the event proxy system 1.

FIG. 12 shows a temporary reservation notification screen. This temporary reservation notification screen is, when the temporary reservation is given from the event manager, displayed on the facility client 3 of the temporary reservation target facility. The event proxy system 1 notifies the facility of the temporary reservation through on the temporary reservation notification screen.

As shown in FIG. 12, a temporary reservation number, a group name of the group making the temporary reservation, an event take-place period, a share of cost and the number of members, are displayed on the temporary reservation notification screen. Further, “print”, “return” and “stop” buttons are provided at the lower portion thereof.

An operator of the facility presses the “print” button on the temporary reservation notification screen displayed on the facility client 3, thereby printing the information on the temporary reservation screen. Moreover, when the facility operator presses the “return” button, an unillustrated main screen is displayed. Further, when the facility operator presses the “stop” button, the facility client 3 is disconnected from the event proxy system 1.

FIG. 13 shows a pre-notice creation screen. The pre-notice creation screen displays pieces information specified by the event manager in a way that fills a template predetermined for every event category with these pieces of information.

As shown in FIG. 13, the pre-notice creation screen is provided with an E-mail address box (To:), a title box (Title:) a notice edit box, and “transmit”, “return” and “stop” buttons.

E-mail addresses of the users of the group to which the event manager belongs, i.e., the group members, are entered in the E-mail address box. The title is set in the template corresponding to the event category. For example, in the case of the golf competition, a title such as “Concerning Golf Competition” is preset.

Further, the information excluding the event date, the share of cost, the facility and the manager name in the text file in the notice edit box, is preset in the template. The event manager may change the text file as he or she intends. Moreover, the event date, the share of cost, the facility (event spot) and the manager name are extracted from the temporary reservation facility information DB 16 shown in FIG. 7 and inserted into the corresponding items in the notice edit box.

On the pre-notice creation screen shown in FIG. 13, when the event manager presses the “transmit” button, the pre-notice is delivered to the E-mail addresses entered in the E-mail address box. The group members determine from this pre-notice whether they participate in the event, and notify the event manager of their answers.

The event manager, when the number of answers about the participation becomes a predetermined number or larger, notifies the event proxy system 1 of a formal contract. When establishing the formal contract, the event manager specifies a formal date. Further, the event manager selects one facility where the event takes place from among the temporarily reserved facilities.

When the event manager presses the “return” button, the temporary reservation confirmation screen shown in FIG. 11 is displayed. When the event manager presses the “stop” button, the user client 2a is disconnected from the event proxy system 1.

FIG. 14 shows a formal contract screen. When the event manager notifies the event proxy system 1 of the formal contract, the event proxy system 1 displays the formal contract screen on the user client 2a.

The formal contract screen displays a reservation number, a facility name, an event schedule, a share of cost, the number of members, a message, and “notice”, “return” and “stop” buttons. Among these items, the reservation number is a number for identifying the reservation of the facility in the event proxy system 1. Further, the message is a message addressed to the event manager from the facility where the event is held. This message is saved on the facility information DB 14.

When the event manager presses the “notice” button, the notice is created and transmitted. This procedure is the same as in the case of creating the pre-notice and therefore its explanation is omitted. When the event manager presses the “return” button, the display returns to an unillustrated main screen. Moreover, when the event manager presses the “stop” button, the formal contract is canceled, and the user client 2a is disconnected from the event proxy system 1.

FIG. 15 shows a cancel screen on which the facility entrepreneur is notified of the cancel. The event proxy system 1 displays the cancel screen on each of the facility clients 3 of the facilities with the formal contract canceled among the temporarily reserved facilities. The facility entrepreneurs are thus notified of the cancel of the temporary reservation.

The cancel screen displays a temporary reservation number, a group name, an event period(take-place period), a share of cost, the number of members, a message, and “confirm” and “return” buttons. The temporary reservation number, the group name, the event period, the share of cost and the number of members among these items, are the same as those on the temporary reservation notification screen (FIG. 12) when making the temporary reservation.

Pieces of disclosure information of the group that canceled the temporary reservation is displayed in the message box. These pieces of disclosure information are, e.g., a location, an average handicap, an event count, a name and an E-mail address of the representative manager, the number of members, an average age and an average budget.

<Operation and Effects>

FIGS. 16 through 21 show processes executed by the user client 2a the facility client 3 or the event proxy system 1. FIG. 16 is a flowchart showing a participant registration process by the user client 2a. based on this process, the event manager requests the event proxy system 1 to register the event participants and to plan the event.

To start with, the user client 2a judges whether an event manager's access to the system is the first time or not (S2). If this access is not the first time, the user client 2a receives inputs of the user name and the user ID from the event manager (S3).

Whereas if that access is the first time, the user client 2a functions for the event manager to input the user name and the group name (S4). Inputted pieces of information are transmitted to the event proxy system 1 and registered on the user information DB 12 and the group information DB 13. At this time, the event proxy system 1 defines a user ID of the user and notifies the user client of this user ID. The user, when having a next access, inputs his or her own user ID.

Next, the user client 2a receives an input of the event take-place information (S5).

The event take-place information given herein contains an event name, conditions such as an event date, the number of participants, an event location and a budget, and priorities given to these conditions. Next, the user client 2a transmits the event take-place information to the event proxy system 1 (S5).

FIG. 17 is a flowchart showing an event search process executed in the event proxy system 1. The event proxy system 1, when receiving the event take-place information from the user appointed as the group manager, executes the process shown in FIG. 17.

In this process, the event proxy system 1, to begin with, receives the event take-place information (S11). Next, the event proxy system 1 judges whether or not the event take-place information received contains event information (e.g., an event name) for specifying an event category (S12).

If the event take-place information contains the event information such as the event name and so on, the event proxy system 1 extracts facility information corresponding to the event information out of the facility information DB 14 (S13). Thereafter, the event proxy system 1 advances the control to S14.

Whereas if the event take-place information does not contain the event information such as the event name and so on, the event proxy system 1 advances the control to S14. In this case, it may be assumed that the group manager does not specify the event categories such as the golf, the skiing, the baseball, the banquet and the exhibition, and searches for the events that can be held.

Next, the event proxy system 1 judges whether or not other conditions are specified in the event take-place information (S14). If other conditions are specified, the event proxy system 1 extracts the facility information corresponding to the priority (S15).

Subsequently, the event proxy system 1 judges whether the extracted facilities meets all the conditions specified (S16). If the extracted facilities meet all the conditions specified, the event proxy system 1 generates a list of the facilities, which is to be transmitted to the group manager (S17).

Further, if the extracted facilities are judged not to satisfy all the conditions in S16, the event proxy system 1 judges whether or not the extracted facilities meet a predetermined or larger number of conditions (S18). If the extracted facilities meet the predetermined or larger number of conditions, the event proxy system 1 generates the list of the facilities that is to be sent to the group manager (S19).

Further, if the extracted facilities are judged not to meet the predetermined or larger number of conditions in S18, the event proxy system 1 extracts a predetermined message (S1A). Next, the event proxy system 1 sends the list generated in S17 or S19 or the message extracted in the process in S1A to the user client 2a of the group manager. Thereafter, the event proxy system 1 finishes the event search process.

FIG. 18 is a flowchart showing a result-of-search receiving process executed by the user client 2a. In this process, at first, the user client 2a receives a result of the event search (S21).

Next, the user client 2a judges whether the user as the group manager sets the temporary reservation with respect to the searched result (S22). If the temporary reservation is set, the user client 2a transmits a temporary reservation request to the event proxy system 1 (S24). While on the other hand, if not set, the user client 2a transmits cancel information to event proxy system 1 (S23). Thereafter, the user client 2a finishes the process.

FIG. 19 is a flowchart showing a temporary reservation setting process executed in event proxy system 1. In this process, to start with, the event proxy system 1 receives the temporary reservation request from the user client 2a (S31).

Next, the user client 2a issues a temporary reservation number (S32). Subsequently, the event proxy system 1 judges whether or not there is a request for creating the notice (S33).

If there is the notice creation request, the event proxy system 1 extracts addresses of the group members out of the user information DB 12 (S35). Next, the group manager creates the notice on the basis of the template. Then, the event proxy system 1 multicasts the notice to the group members (S36), and finishes the process.

Whereas if there is no notice creation request, the event proxy system 1 transmits the temporary reservation information to the group manager and the entrepreneur (S34),and finishes the process.

FIG. 20 is a flowchart showing a formal reservation setting process executed in the event proxy system 1. In this process, the event proxy system 1 at first receives a formal reservation request from the user client 2a (S41).

Next, the event proxy system 1 judges which entrepreneur corresponds to this formal reservation request (S42). Namely, the event proxy system 1 issues a reservation number to the formal reservation target entrepreneur (in the case of YES in S42) (S43)

Subsequently, the event proxy system 1 judges whether or not there is advertisement information (which is described as PR information in FIG. 20) of the formal reservation target entrepreneur (S44). If judged to have the advertisement information of the entrepreneur, the event proxy system 1 extracts this item of advertisement information and discount information from the facility information DB 14 (S45).

Next, the event proxy system 1 transmits the advertisement information and the discount information to the user client 2a of the group manager (S46). Thereafter, the event proxy system 1 finishes the process.

On the other hand, the event proxy system 1 extracts the disclosure information of the group having made the temporary reservation to a formal reservation non-target entrepreneur (in the case of NO in S42) (S47). Next, the event proxy system 1 creates a cancel notification attached with the disclosure information (S49). If there is no disclosure information of this group, however, the event proxy system 1 creates a cancel notification with no disclosure information.

Subsequently, the event proxy system 1 sends the cancel notification to entrepreneur (S50). Thereafter, the event proxy system 1 comes to an end of the process.

FIG. 21 is a flowchart showing an entrepreneur registration process executed by the facility client 3 shown in FIG. 1. In this process, to begin with, an operator of the entrepreneur inputs pieces of information on the entrepreneur and the facility to the facility client 3 (S61).

Next, the facility client 3 judges whether or not the input of that item of information is the first time to register the entrepreneur (S62). If the input of that item of information is judged to be the first time to register the entrepreneur, the facility client 3 executes a process of registering the information on the entrepreneur and the facility (S64).

Whereas if judging that the input of that item of information is not the first time to register the entrepreneur, the facility client 3 executes a process of inputting the facility/advertisement information of the entrepreneur already registered (S63).

Next, the facility client 3 transmits the inputted information to the event proxy system 1 (S65). Thereafter, the facility client 3 finishes the process.

As discussed above, the user easily specifies the conditions of the desired event in the event proxy system 1 in this embodiment, and is able to receive the support of the event planning. Hence, the user can set the event category, the event facility, the event period and the budget as the user desires, and thus can hold the event.

Further, according to this embodiment, the formal reservation is made after making once the temporary reservation of the facility. Accordingly, the user is able to initially have the temporary reservations of the facilities in a comparatively wide range, and narrow down the facility range as the planning progresses. Therefore, the user can select a more appropriate facility in accordance with a progress situation of the planning.

Moreover, the facility receiving the temporary reservation can expect a formal reservation to some extent in the future and estimate a customer demand. Still further, even if the temporary reservation is canceled, the facility with the reservation canceled is notified of the disclosure information of the event-scheming group, for instance, the average event count, the budget and so on. Therefore, each facility may access the users on the basis of the event disclosure information. For example, the facility can predict a time when the next event will take place and timely release its own facility advertisement to the users.

Moreover, the event proxy system 1 according to this embodiment is capable of specifying the priority given to each condition contained in the event take-place information. Hence, even if unable to extract the optimal facility at the event holding time, it is feasible to find out the facility next to the optimum.

<Modified Example>

In accordance with the embodiment discussed above, as shown in FIGS. 3 through 7, each record of data of the database is given “No.” for identifying the record of data. The embodiment of the present invention is not, however, limited to this structure. As a substitute for this identification element “No.”, for instance, each record of data may be identified by a record address on an unillustrated recording device, i.e., a hard disk etc. for retaining the database. Accordingly, the present invention can be embodied in structures with no such identifying element as “No.” unique to each record of data of the database.

According to the embodiment discussed above, the user is identified by the user name, the group is identified by the group name, and the facility is identified by the facility name. The embodiment of the present invention is not, however, confined to the structure and procedure described above. For example, the user, the group and the facility may be identified by a user ID, a group ID and a facility ID.

In the embodiment discussed above, the information on the result-of-search display screen shown in FIG. 10 is searched from the facility information DB 14. The embodiment of the present invention is not, however, restricted to the structure and procedure explained above. For instance, a category of the event to be held in each facility and an address, e.g., an E-mail address of an inquiry destination, maybe recorded on the facility information DB 14, and it may be inquired of each facility whether it meets the conditions specified on the event take-place information input screen shown in FIG. 9. Namely, the event proxy system 1 may transmit the event conditions to the facility client 3 of each facility and may ask the client 3 to send an answer of whether it meets the conditions back to the system 1. The event proxy system 1 may transmit a list of the facilities making the reply that they meet the conditions, to the user client 2a of the event manager.

In the embodiment discussed above, the handicap of the user is recorded in the “HC” field and the type of the club for shot is recorded in the “forte” field on the user information DB 12. The embodiment of the present invention is not, however, limited to the structure described above. For example, a user's handicap in athletic capacity in skiing, baseball etc, a handicap in proper quantity of drinking a liquor at the banquet and a handicap in singing a song at a Karaoke session, may also be recorded. In addition, a category of sport at which the user is good, the best defensive position in a baseball game, a favorite song at the Karaoke session and so on, may also be recorded. The event proxy system 1 may search for a proper facility based on the handicap and forte information described above.

According to the embodiment discussed above, the group members notify the event manager of their answers about whether they participate in the event or not. The embodiment of the present invention is not, however, limited to this answer system described above. For example, there may be taken a system in which the individual group members give answers about their participation directly to the event proxy system 1. In this case, the event proxy system 1 may collect the answers of the group members and inform the user client 2a of the group manager of this collected result.

<Readable-by-Computer Recording Medium>

The program executed by the control unit 11 in the event proxy system 1 in the embodiment discussed above may be recorded on a readable-by-computer recording medium. Then, the computer reads and executes the program on this recording medium, thereby functioning as the event proxy system 1 shown in the embodiment discussed above.

Herein, the readable-by-computer recording medium embraces recording mediums capable of storing information such as data, programs, etc. electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8 mm tape, a memory card, etc..

Further, a hard disk, a ROM (Read Only Memory) and so on are classified as fixed type recording mediums within the computer.

<Data Communication Signal Embodied in Carrier Wave>

Furthermore, the above program may be stored in the hard disk and the memory of the computer, and downloaded to other computers via communication media. In this case, the program is transmitted as data communication signals embodied in carrier waves via the communication media. Then, the computer downloaded with this program can be made to function as the event proxy system 1 in the embodiment discussed above.

Herein, the communication media may be any one of cable communication mediums such as metallic cables including, e.g., a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave maybe anyone of a modulated broadband signal and an unmodulated base band signal (corresponding to a case of setting a DC signal having a voltage of 0 as a carrier wave).

What is claimed is:

1. A server, acting as a proxy between a user desiring to hold an event and a facility where the event takes place, for supporting arrangements of an event manager, said server comprising:
a communications module providing function of communications between a user client for providing the user with an accessing function to a network and a facility client serving as an information processing device of the facility on the network;
a user information recording module recording information on the user;
a facility information recording module recording information on the facility; and
a control unit;
wherein said control unit receives an event planing request notification from a first user client, searches for a facility suited to this event out of said facility information recording module, transmits a reservation-for-use notification to said facility client of the facility searched, and notifies a second user client recorded on said user information recording module, of a notice of the event.

2. A server according to claim 1, wherein said control unit notifies a plurality of facility clients of temporary reservations, and, after receiving a reservation request from said first user client, notifies each of said facility clients notified of the temporary reservations, of either a formal reservation or a cancel of temporary reservation.

3. A server according to claim 2, wherein said control unit, together with the cancel of the temporary reservation, notifies said facility client of the facility with the temporary reservation canceled, of disclosure information on participants in the event concerned.

4. A server according to claim 1, wherein said control unit accepts an application for the participation in the event from said second user client.

5. A server according to claim 1, wherein a condition about at least one of a category of the event to be held, an event holding date and time, an event holding location and a budget, is specified in the event planning request notification.

6. A server according to claim 5, wherein a priority is specified as the condition.

7. A server according to claim 1, further comprising a group recording module recording groups to which the users belong,
wherein planning of an event for a given group is requested in the event planning request notification, and
said control unit informs said user client of the user belonging to the group concerned, of the notice of the event.

8. A server according to claim 7, wherein said group recording module is recorded with pieces of information showing categories of the events desired by the respective groups and information on an event count indicating how many times the event takes place, and
said control unit predicts a time when the next event will takes place on the basis of the event count, and notifies said user clients of an event planning notice before the predicted event take-place time.

9. An event proxy method for a proxy between a user desiring to hold an event and a facility where the event takes place in a system including a user client serving as a device for accessing a network and a facility client serving as an information processing device of the facility on the network,
said method comprising:
receiving an event planning request notification from a first user client;
searching for a facility suited to this event;
transmitting a reservation-for-use notification to said facility client of the facility searched; and
informing a second user client of a notice of the event.

10. An event proxy method according to claim 9, further comprising:
a first notifying a plurality of facility clients of temporary reservations; and
a second notifying, after receiving a reservation request from said first user client, each of said facility clients notified of the temporary reservations, of either a formal reservation or a cancel of temporary reservation.

11. An event proxy method according to claim 9, wherein said facility client of the facility with the temporary reservation canceled is notified of disclosure information on event participants in said notifying step.

12. An event proxy method according to claim 9, further comprising accepting an application for the participation in the event from said second user client.

13. An event proxy method according to claim 9, wherein a condition about at least one of a category of the event to be held, an event holding date and time, an event holding location and a budget, is specified in the event planning request notification.

14. An event proxy method according to claim 13, wherein a priority is specified as the condition.

15. An event proxy method according to claim 9, further comprising referring to information on groups to which the users belong,
wherein said user clients of the users belonging to the group are informed of a notice.

16. An event proxy method according to claim 15, further comprising:
referring to pieces of information showing categories of the events desired by the respective groups and information on an event count indicating how many times the event takes place; and
predicting a time when the next event will takes place on the basis of the event count; and
notifying said user clients of an event planning notice before the predicted event take-place time.

17. A readable-by-computer recording medium recorded with a program, executed by a computer, for a proxy between a user desiring to hold an event and a facility where the event takes place in a system including a user client serving as a device for accessing a network and a facility client serving as an information processing device of the facility on the network,
said program comprising:
receiving an event planning request notification from a first user client;
searching for a facility suited to this event;
transmitting a reservation-for-use notification to said facility client of the facility searched; and
informing a second user client of a notice of the event.

18. A readable-by-computer recording medium recorded with a program according to claim 17, further comprising:
a first notifying a plurality of facility clients of temporary reservations; and
a second notifying, after receiving a reservation request from said first user client, each of said facility clients notified of the temporary reservations, of either a formal reservation or a cancel of temporary reservation.

19. A readable-by-computer recording medium recorded with a program according to claim 17, wherein said facility client of the facility with the temporary reservation canceled is notified of disclosure information on event participants in said notifying step.

20. A readable-by-computer recording medium recorded with a program according to claim 17, further comprising accepting an application for the participation in the event from said second user client.

21. A readable-by-computer recording medium recorded with a program according to claim 17, wherein a condition about at least one of a category of the event to be held, an event holding date and time, an event holding location and a budget, is specified in the event planning request notification.

22. A readable-by-computer recording medium recorded with a program according to claim 21, wherein a priority is specified as the condition.

23. A readable-by-computer recording medium recorded with a program according to claim 17, further comprising referring to information on groups to which the users belong,
wherein said user clients of the users belonging to the group are informed of a notice.

24. A readable-by-computer recording medium recorded with a program according to claim 23, further comprising:
referring to pieces of information showing categories of the events desired by the respective groups and information on an event count indicating how many times the event takes place;
predicting a time when the next event will takes place on the basis of the event count; and
notifying said user clients of an event planning notice before the predicted event take-place time.
